(19) United States
(12) Patent Application Publication
(10) Pub. No.: US 2011/0232551 A1
(43) Pub. Date: Sep. 29, 2011

(54) Earth working digging tool and system for digging holes in ground

(76) Inventor: Ekramul Haque, Manhattan, KS (US)

(21) Appl. No.: 13/066,968

(22) Filed: Apr. 29, 2011

(51) Int. Cl. A01C 5/04

(52) U.S. Cl. 111/89

(57) ABSTRACT

This invention was intended to develop an earth working equipment and system for digging holes in ground particularly in agricultural soils for needs including but not limited to transplanting of seedlings of flowers, vegetables, fruits, bushes, and shrubs; and for making holes for other purposes where hollow-cylindrical shapes are desired. One very important feature of the equipment is the provision of a removable or embeddable cylindrical retaining wall around the hole being dug thus preventing hole-deforming avalanches of soils, common in trowel assisted hole digging that results in V-shaped rather than cylindrical shaped holes. This provision and other features of the equipment ensure formation of consistent hollow-cylindrical holes effectively, efficiently and economically. The equipment consists of a tilling tool to loosen the soil, a screw conveyor to dig into and transport the soil away, and a cylindrical retaining wall to maintain cylindrical shape of the hole by preventing soil avalanches.

### TECHNICAL FIELD OF INVENTION

The invention relates to a physical treatment of earth more particularly agricultural soils for making holes in the ground for such purposes including but not limited to transplanting of seedlings of flowers, vegetables, fruits, bushes and shrubs; and secondarily for making holes in any soil for many other purposes where clean cut hollow-cylindrical holes in the ground are desired

### BACKGROUND OF THE INVENTION

Transplanting plant seedlings, bushes, and shrubs from a temporary starter location to a final growing place is a widely used practice all over the world in agricultural and landscaping practices. Seeds are usually planted indoors in containers of various sizes, shapes and materials and seedling beds while the outside weather could still be too early, and unfavorable for plant growth. These seedlings are transplanted during the growing season to various locations including gardens, outdoor and indoor pots, small and big plots of lands and many other locations. Also, indoor transplantation to pots of various sizes is done all around the year irrespective of the plant growing season.

In the USA and elsewhere, various plant seedlings including flowers, vegetables, fruits, greeneries such as shrubs and trees are grown in non-compartmented and compartmented seedling trays or pots in environmentally-controlled nurseries and many other seedling beds. These seedlings are sold to the populace in popular garden centers, large retail stores, groceries and many other places.

Transplanting imposes stress on the seedlings because of the change of the environment and other conditions in the new home of seedlings, and unintended damages to the plant during transplanting. For transplanting, it is a common practice to dig a hole large enough to accommodate the soil-root structure of the seedlings as undisturbed and undamaged as possible, and to keep the surrounding soils of the hole minimally compacted to allow rapid root growth in the new location, yet filling big air pockets in the soil. Additionally, seedlings should be embedded into the soils making sure that the entire root structure is totally under the soil and the plant is trained vertically upward.

Shovels and trowels of various shapes and sizes are used to dig into the soil to make holes. While shovels and trowels serve the purpose for the most part, they have some major draw backs. Trowels typically come in the shape of spades. They function well especially for heavy and wet clay type soil, but are incapable of making the right shape and size of holes especially when the soil particles are small, and relatively friable, dry and loose, for example garden soils, sandy, sandy loom, and potting soils. The holes the trowels make are of inconsistent size and shape, generally of V-shapes or cones, wider at the soil surface and narrower as the depth increases. The V-shape of the hole is caused by the shape of the shovel and the avalanche of soil particulates around the holes during digging. Avalanches and the shape of the shovel cause deformation of the hole, and make it impossible to dig a consistent size and shape of the hole. The inconsistency in size and shape make it necessary to dig into the soils repeatedly requiring a long digging time and effort. For transplanting bigger seedlings for trees and other plants, and compacted heavy soils various designs of earth augers are used to make cylindrical holes of various sizes, but they are also not generally suitable for sandy, sandy loam, top, potting and garden soils because of the free flowing, collapsible and friable nature of the soil. A tool that will allow making a consistent and desirable size and shape of a hole such as a hollow cylinder in every try will greatly reduce time, labor and cost of transplanting, and will make transplanting effective, efficient and economical.

Therefore, a need exists to develop a new tool to dig holes in the soil operated either manually or by electrical power that could eliminate the problems explained above. This new tool could also be designed to allow embedding of slow release nutrients, foods, and weed and insect control ingredients, integrally contained within a biodegradable but hole-size and shape maintaining means simultaneously while digging hole.

### BRIEF SUMMARY OF THE INVENTION

The problems outlined above are in large measure solved by the Earth Working Digging Tool and System for Digging Holes in the Ground in accordance with the present invention. In accordance with the present invention, an equipment and system are provided to dig hollow-cylindrical holes of consistent size and shape effectively, efficiently, economically and quickly. One of the most important features of the equipment is the provision of a shield or retaining wall assembly around the cylinder surface as the hole is dug thus preventing hole-deforming avalanches of soils around the hole. The retaining wall assembly is either removable from the soil after the transplantation is completed, or remains embedded in soil permanently. The removable retaining wall assembly should be made of a hard and not-easily deformable material such as a metal or a plastic of appropriate thickness and be reusable. This cylindrical retaining wall assembly should be made of two equal halves of semi-cylinders each being detachable from the other so that the wall could be easily removed from the soil after the completion of the transplantation work, especially in case, the bush above the roots is large compared to the retaining wall diameter. If the retaining wall is to remain embedded in soil permanently, the wall could be one complete hollow-cylinder, need not be made of two halves of semi-cylinders and should be made of biodegradable materials; and some slow release plant nutrients, foods and insect control ingredients could be added to the wall material. The provision of the retaining wall and other features of the equipment ensure the formation of consistent hollow-cylindrical holes of consistent shape and size.

The digging tool according to the present invention broadly includes a helical screw conveyor assembly having appropriate flighting dimensions and rotational direction, the said screw having a separate digging cum collecting end and a discharge end, said digging end having a cone shaped shroud or canopy that diverges towards digging end radially outwardly to help increase the soil collecting radius of the hole being dug, in comparison to the absence of canopy, the said canopy preventing the radial flow of soil away from the center of the screw and no facilitating the movement of the soil towards collecting end of the screw; a cylindrical encasement or screw housing on which the said canopy is mounted; a cylindrical retaining wall slightly of larger inner diameter than the outer diameter of the canopy so that the said canopy and screw assembly can be easily slided axially into the inside of the said cylindrical retaining wall; and a tilling tool mounted on the screw shaft at the tip of the digging end, said tilling tool being of length somewhat smaller than the outer diameter of the canopy, and provided with tilling bits of shapes that ensure directing soils not only towards the center of the screw shaft and but also axially towards the discharge end. The said cylindrical retaining wall prevents avalanche formation and helps maintain a hollow-cylindrical shape of the hole dug. The power drive consists of hand driven or power driven mechanism to affect the rotation of the screw. The discharge end of the screw is provided with a chute to remove displaced soils from the cylindrical hole being dug, and a collection container to collect the soil from the chute. After completion of digging of the hole, the screw assembly is removed leaving the cylindrical retaining wall assembly embedded in the soil. The cylindrical retaining wall is either removed only after positioning and securing the seedlings in the hole at appropriate locations, or if made of biodegradable materials containing plant nutrients, food, and insect and weed control is permanently left in the ground.

### BRIEF DESCRIPTION OF THE DRAWING

FIG. 1 is a schematic view of the Earth Working Digging Tool and System for Digging Holes in the Ground in accordance with the present invention.

FIG. 2 is a schematic plan view of the two semi-cylindrical halves that make the unfolded assembly of cylindrical retaining wall

FIG. 3 is a schematic view of the folded position of the two semi-cylindrical halves that make the cylindrical retaining wall

### DETAILED DESCRIPTION OF THE INVENTION

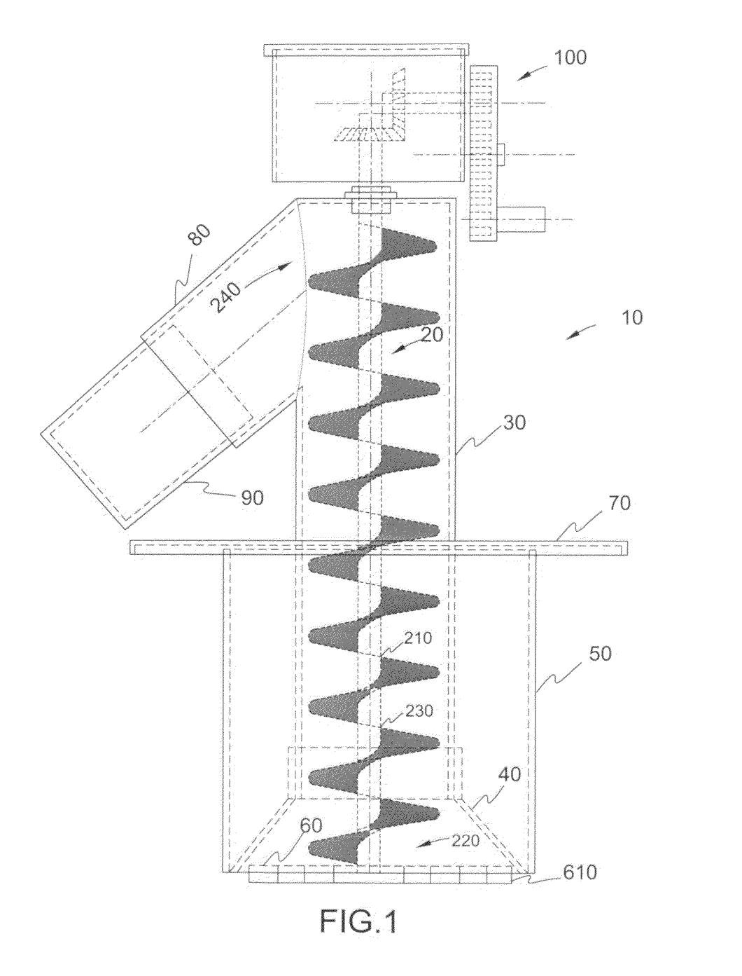

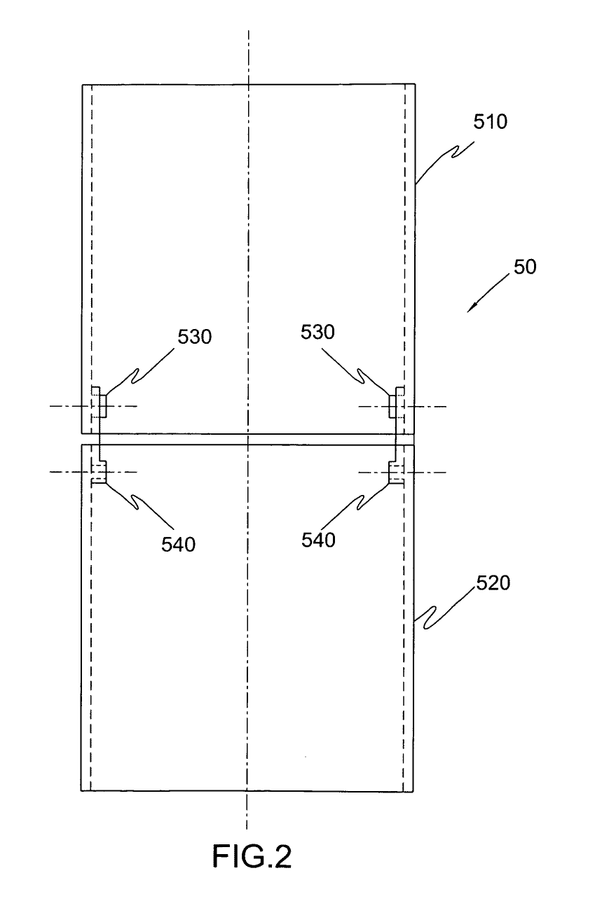

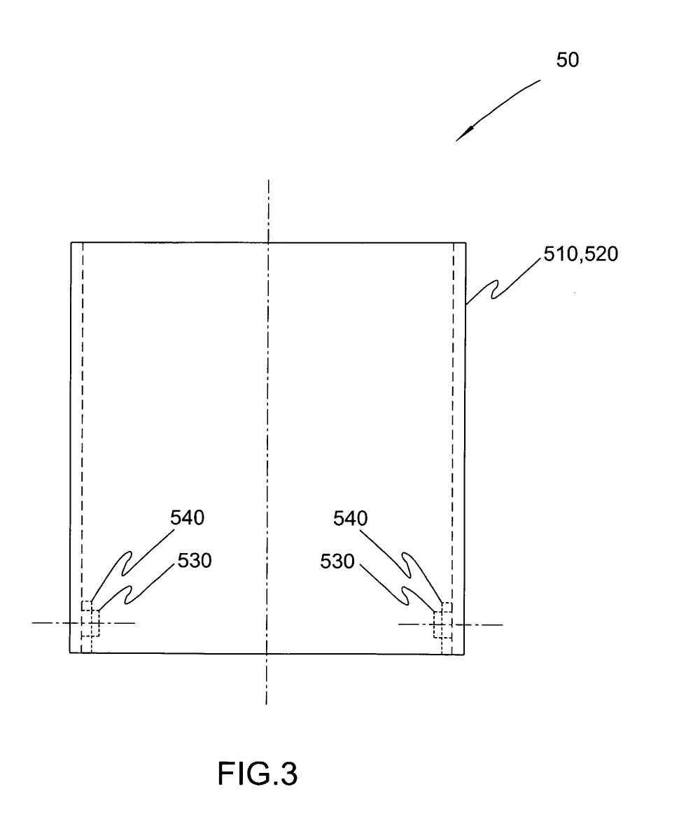

Referring now to the drawing of FIG. 1, Earth Working Digging Tool and System for Digging Holes 10; in accordance with the invention broadly includes helical screw assembly 20; cylindrical screw housing 30; canopy 40; cylindrical retaining wall assembly 50 (FIG. 2 and FIG. 3) which consists of two semi-cylindrical halves 510 and 520, hinged (530 and 540) together but easily detachable from each other as and when needed especially when said retaining wall is to be removed from within the soil after completion of the transplantation, said retaining wall being made of hard and not-easily deformable material such as metals or plastics, or alternatively if the retaining wall 50 is desired to be permanently embedded into the soil around the plant root system the retaining wall is made of biodegradable materials of hollow cylindrical shape with slow release plant nutrients, foods, and insect control ingredients contained in the wall; tilling tool 60 which is mounted on screw shaft 230; pushing means 70; discharge chute 80; soil collecting means 90; and power means 100.

For making a hole in the ground, first, the cylindrical retaining wall 50 in its folded position (FIG. 3) is rested on its hinged end (FIG. 2, FIG. 3) on the top of the soil vertically and concentrically to the desired location of a hole. Then, the canopy cum screw assembly along with the drive 100 is inserted concentrically into the retaining wall 50 until the digging end 220 rests on the soil. The equipment 10 is pressed down to the soil making sure the tilling tool 60 somewhat penetrates the top strata of the soil. The power means 100 is then operated to facilitate rotation of the screw shaft 230, flighting 210 and tilling tool 60. The tilling tool 60 starts rotating and thereby tilling the soil and also facilitating the movement of the soil towards the center of the screw shaft with the help of the tilling tool bits 610; and simultaneously, the screw flighting 210 also starts rotating and transporting soil vertically upwards. The canopy 40 ensures that the tilled soil is confined to the space formed by the canopy near the collecting end 220 of the screw flighting 210 thus facilitating the transport of the soil to the discharge end 240. The canopy is also intended to provide a shield against the flow of the soil into the annular space between the screw housing 30 and the cylindrical retaining wall 50. The tilling bits 610 impart locomotion to the tilled soil to migrate towards the shaft center and upwards in the direction of the discharge end 240 of the screw. The canopy, tilling tool, and tilling bits are essential for ensuring making of a hole bigger than the size of the screw housing.

As the soil is dug into by using the power means 100, transported to the discharge end and collected in the collecting means 90, open space becomes available in the soil; and some downward pressure from body weight of the operator on the equipment 10 gradually inserts the retaining wall 50 and the screw assembly into the soil deeper and deeper thus accomplishing digging of the hole as desired. After the appropriately sized hole is dug, the screw assembly is lifted away leaving the retaining wall embedded in the soil. Then the plant is positioned in the hole, trained and secured in place by pouring some of the soil collected in the collection means 90 around the plant. Once the plant is securely positioned in the hole, the cylindrical retaining wall 50 is either taken out by gradually unfolding the two halves as the retaining wall is lifted up from the hole; or if biodegradable retaining wall is desired the wall is left within the ground and the job is finished. Making the cylindrical retaining wall from two semi-cylindrical halves and articulating a hinged connection that ensures connecting and detaching the two halves allow taking out the retaining wall if and when the plant foliage above the ground is substantially bigger than the diameter of the retaining wall.

I claim:

1. An equipment and system for Earth Working Digging Tool for digging holes in the ground comprising:
a helical screw conveyor assembly having appropriate flighting dimensions and rotational direction, said screw being mounted on a screw shaft and having two ends, a separate digging cum collecting end and a discharge end;
a cylindrical encasement or housing around said screw extending from the collecting to the discharge end;
a canopy integrally mounted to said housing at digging end, said canopy being of cone shape and diverging towards radially outwardly to help increase the radius of the hole being dug, in comparison to absence of canopy, said canopy blocking the flow of soil beyond the boundary formed by the canopy and collecting end of the screw;
a hollow-cylindrical retaining wall assembly that is pushed in the soil along with said screw assembly so as to prevent soil avalanches that are commonly formed in existing digging methods from deforming the desired size and shape of the hole;
a tilling tool mounted on said screw shaft at the tip of the digging end, said tilling tool being of length slightly smaller than the outer diameter of the canopy, and provided with tilling tool bits of shapes that ensure directing soils not only towards the center of the screw shaft but also axially towards the discharge end;
a pushing means mounted to the said screw housing at an appropriate location to push the said hollow-cylindrical housing down into the hole as the hole is dug;
a discharge chute integrally mounted to the discharge end of screw housing so as to facilitate expelling the soils in a place outside of the hole being dug;
a collecting means connected to said discharge chute to collect the said expelled soil in a container so as to reuse the soil for back filling the hole dug into; and
a power means to provide motive power to the operation of equipment by hand cranking or electrical means.

2. The hollow-cylindrical retaining wall assembly of claim 1 being made of not easily-deformable but reusable metal or plastic, and composed of two nearly equal halves of semi-cylinder, each half being detachable from and re-attachable to the other, such that each half can be removed independently of the other after the completion of the transplantation, especially when, the foliage and branches of transplanted plant above the root system is substantially larger than said cylindrical retaining wall diameter, said retaining wall being of slightly larger inner diameter than the outer diameter of said canopy so that said canopy and said helical screw assembly can easily be slided axially in and out of the inside of said cylindrical retaining wall and said retaining wall serving as a shield against the formation of soil avalanches which are common in holes dug by hand trowels and said retaining wall being left embedded in the soil until the plant being transplanted is securely and appropriately positioned in the hole, and said retaining wall being removed only after the plant is securely positioned in the desired location using some of the soils collected by using said collecting means or alternatively, said retaining wall being made of hard but biodegradable materials and containing slow release plant nutrients and foods and insect and weed control ingredients and if said retaining wall is made of biodegradable materials the cylindrical retaining wall is to be left in the ground permanently with the transplanted plants, shrubs and trees.
